(19) United States
(12) Patent Application Publication
(10) Pub. No.: US 2007/0119554 A1
(43) Pub. Date: May 31, 2007

(54) Insect screens that can be replaced

(76) Inventor: James Guffey, Ft Myers, FL (US)

Correspondence Address: James Guffey, 6368 Emerald Pines Circle, Ft. Myers, FL, 33912, US

(21) Appl. No.: 11/337,845

(22) Filed: Jan. 23, 2006

Related U.S. Application Data
(63) Continuation-in-part of application No. 11/286,402, filed on Nov. 25, 2005.

(51) Int. Cl. E06B 9/24

(52) U.S. Cl. 160/371

(57) ABSTRACT

An enclosure is placed over a pool or patio and the enclosure consists of vertical columns and horizontal beams including screening material placed between said columns and/or beams. Each of the columns and horizontal beams have channels therein and a fastening tape is placed each into the channels. The tape is constructed of a multitude of stems thereon. Each of the stems have mushroom heads thereon. The mushroom heads will penetrate through interstices in the screening material when the screening material is pressed over the mushroom heads, whereby the screening material is held firmly in place.

This is a Continuation-In-Part of application Ser. No. ______

### FIELD OF THE INVENTION

Insect screens frequently need to replaced because they are damaged by environmental incidents, deterioration or by human intervention. The screens are found in cages over lanais and swimming pools as enclosures and in window coverings as well as rolling doors.

### BACKGROUND OF THE INVENTION

The copending application emphasizes that recent hurricanes caused great damage to the above mentioned enclosures by simply blowing the screens from their supports be it vertical or horizontal supports These screen enclosures are no match for the high winds occasioned by the hurricanes, the force of the rain and/or flying debris.

### BRIEF SUMMARY OF THE INVENTION

The inventive replaceable screens using a simple tape instead of the well known splines or the VELCRO tapes that are attached to both the support and the screen material. In the copending application, through the use of VELCRO, it is necessary to apply a tape to the spline that is attached to the support stanchions of either a loop or a hook system and the opposite tape of the other selected hook and loop system. When a storm approaches, it is easy to peel the screen off the splines and to store the screen material in a safe location. After the storm passes it is easy to reassemble the screen enclosure. It is happening that one of the screen edges get torn or damaged when removed, whereby a new loop or hook strip of the VELCRO system has to be reattached or a new piece of material has to be prepared.

The inventive concept makes it much easier to initially install the screen material, remove the existing screen material or to build an entirely new enclosure. The inventive concept relies on only one tape having tiny mushroom tipped stems that can easily penetrate the interstices of the woven screen material to firmly lock the material in place. The tape is manufactured by the 3M™ Co. under the Trademark Dual Lock™. The above identified fastening system consists of two tapes having the same tiny mushroom heads that interlock with each other. The Dual Lock™ system is a unique attachment system that creates quick, reliable and separable connections. The inventive concept uses only one tape whereby the tiny mushroom heads can easily penetrate into the interstices of the woven screen material to provide a firm hold of the screen material.

### BRIEF DESCRIPTION OF THE DRAWINGS

FIG. 1 is a representation of the prior art;

FIG. 2 is an installation of screen material in a window, in part of an enclosure or a sliding door;

FIG. 3 illustrates a connection of screen material in either a horizontal or vertical support column;

FIG. 4 shows how the screen material is attached to a single tape having mushroom heads.

### DETAILED DESCRIPTION OF THE INVENTION

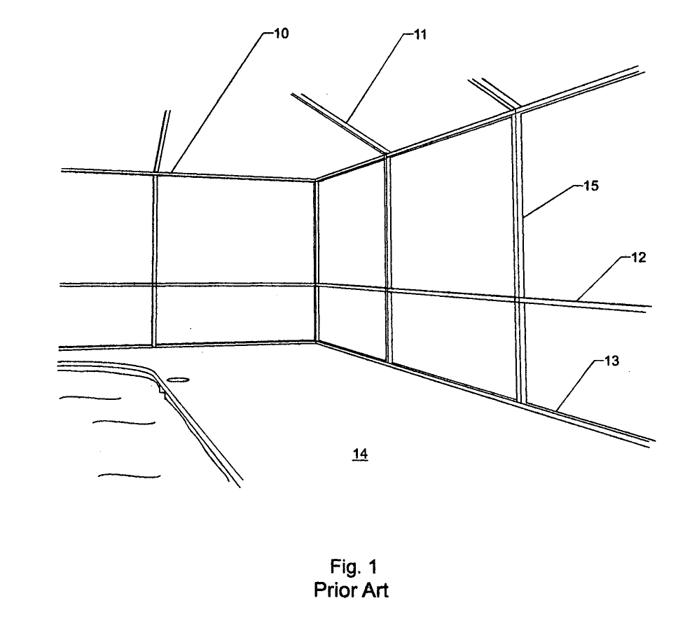

FIG. 1 is a typical prior art installation of a screen cage over a pool area. The same or similar installation can be found in a cage or enclosure over a lanai. The cage consists of upper, middle and lower horizontal connecting beams 10, 12 and 13. The connecting beams are attached to the upright columns or stanchions 15 which have roof trusses 11 attached at their tops.

The columns and the horizontal beams are of a hollow construction and are made of aluminum or other strong extruded plastic material. Mostly they have either a square or rectangular profile or cross section. They are also profiled to have grooves therein to receive longitudinal fastening strips therein that will receive the screen material thereon which will be explained below. At 14 is shown a deck of a swimming pool which could also be a terrace of a lanai.

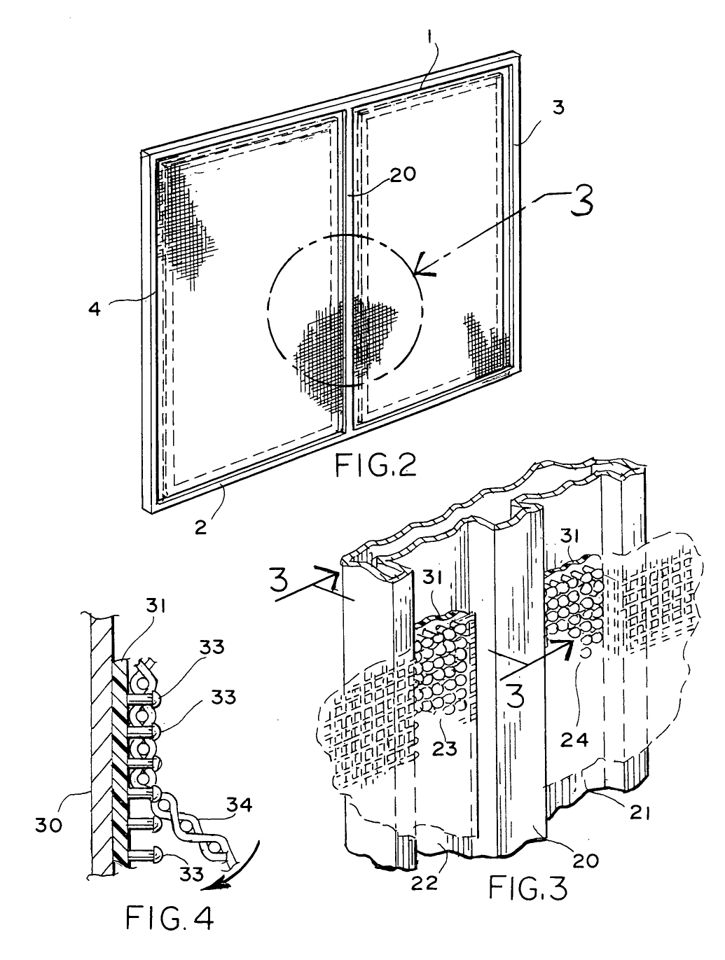

FIG. 2 is a perspective view of a frame having a screening material thereon which frame could be attached over a window, it could be part of a sliding screen door or could be part of the enclosure as shown in FIG. 1. The numeral 1 depicts an upper frame member and 2 is a lower frame member. The numerals 3 and 4 illustrate right and left frame members, respectively. There is also shown a center frame member 20 which could be any of the frame members 10-13 and 15 of the enclosure shown in FIG. 1.

FIG. 3 is a more detailed illustration of how the screen material is attached to the various frame members. In this illustration there is shown a basic longitudinal frame member 20. The frame member could be made of extruded aluminum. The illustration shows a double stanchion having two depressions or channels 21 and 22 therein although only one would suffice in certain areas of any installation where an end of a structure appears.

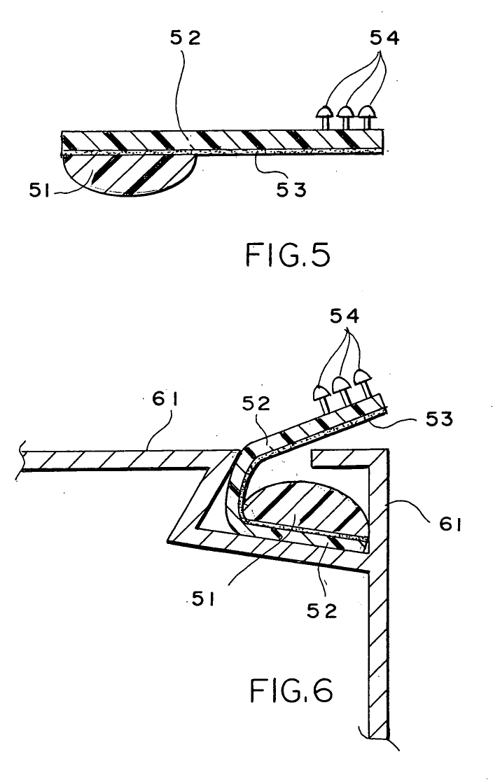

In FIG. 3 either one or the other or both of the channels 21, 22 receive a fastening tape 25, 26 which is identified as a mushroom head stem tapes wherein the stems are each carrying or having attached thereto a tiny mushroom head (see FIG. 4 to be explained below). The mushroom head tapes have been identified as being made by the 3M™ company under the trade name of Dual Lock™ attachment system is known as the tiny mushroom-shaped stems, less than a millimeter in diameter provide a rapid connections. There are up to 62 such tiny heads per square centimeter. The Dual Lock™ Tape is available in 170, 250 and 400 stems per square inch. A selection would depend on the weave of the screen material that is being used in any of the planned constructions. One other advantage of using the above identified fastening tape is that the screen material can be placed over the fastening tapes for purpose of adjustment or aligning without adhering to the tape. This is another advantage over the VELCRO tapes of the prior art where an instant adhering may be happening. After the screen material has been aligned over the inventive tape without adhering to it, it can now be connected to the tape by a hand or a certain tool.

FIG. 4 shows a partial adherence of the screen material 34 over the tiny heads 33 of the mushroom stem tape 31. The tape itself could be chosen from a wide selection of the 3M™ Acrylic foam tapes that are available in many different thicknesses. This adhesive technology makes it easy to bond the 3M™ Dual Lock™ fasteners to any selected components. The channels could be constructed or extruded so that the tape would have a snap-fit connecting within the channel so that the tape could also be recovered, when the need arises by forcibly pulling the tape out of the channel. This could only be accomplished when the tape is pulled straight out of the channel and not laterally thereto. The interstices in the weave of the screen material will easily slip over the mushroom heads and will thereafter be held firmly in place. A manual force will peel the screen material away and from under the mushroom heads if the necessity arises such as replacing a damaged screen or changing the basic construction of any enclosure. The removed screen material can be used all over again in a different environment or installation.

What I claim is:

1. A system of applying a screen material to a frame, said frame consisting of vertical support columns and horizontal connecting beams, each of said columns and said beams having channels therein, said channels having a single tape placed therein, said tape consisting of a multitude of stems having mushroom heads at an outer end thereof, said screen material having interstices provided therein, said mushroom heads penetrating through said interstices when pressure is applied to said screen material, said mushroom heads holding said screen material firmly in place.

2. The system of claim 1 including means for fastening said tape into said channels.

3. The system of claim 2, wherein said means for fastening is an adhesive.

4. The system of claim 2, wherein said means for fastening is a snap-fit system.

5. The system of claim 1, wherein said frame is a pool enclosure.

6. The system of claim 1, wherein said frame is a patio enclosure.

7. The system of claim 2, wherein said means for fastening is a spline having a profile to be pressed into said channels, said spline extending into a backing tape having said mushroom heads on one side and having an adhesive backing on another side.
